(19) United States
(12) Patent Application Publication
(10) Pub. No.: US 2007/0133194 A1
(43) Pub. Date: Jun. 14, 2007

(54) Lighting ashtray apparatus using solar energy

(76) Inventor: Peixing Deng, Shenzhen (CN)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/602,944

(22) Filed: Nov. 21, 2006

(30) Foreign Application Priority Data
Dec. 1, 2005 (CN) 200520119926.9

(51) Int. Cl. F21V 33/00

(52) U.S. Cl. 362/154

(57) ABSTRACT

A lighting ashtray apparatus using solar energy relates to a new practical apparatus for smokers. It comprises an ash container, wherein a solar energy lighting device is configured on the top of the ash container, the said solar energy lighting device and the said ash container are configured and fixed on the support bracket; the said solar energy lighting device comprises an outer cover, photovoltaic cells, a rechargeable battery, a circuit controlled panel and a illuminant, wherein the photovoltaic cells are embedded on the upper surface of the outer cover, and the said rechargeable battery and the circuit controlled panel are configured inside of the said outer cover, and the said photovoltaic cells are connected to the said circuit controlled panel electrically which is further connected with the said rechargeable battery and the illuminant electrically. The said ashtray apparatus can be set on the trunks, the walls of buildings or other supporting objects in the open public places relying on its own support bracket when it is used. Compared with the prior art, the said ashtray apparatus can light by itself at night, which is of ease of use for smokers and meanwhile benefit for environmental protection.

### THE FIELD OF THE INVENTION

The present invention relates to a new practical apparatus for smokers, especially relates to an ashtray apparatus of generating and storing electricity and lighting using solar energy.

### BACKGROUND ART

The prior art of ashtray apparatus used in the open public places is not provided with the function of lighting itself and either inconvenient for users at night inasmuch as smokers tend to flip the cigarette ash to the outside of the ashtray accidentally, which causes environmental pollution. Furthermore, lighting devices specially set in some places results in high cost without saving energy.

### SUMMARY OF THE INVENTION

What the present invention aims to solve is to avoid the deficiencies of the prior art mentioned above by bringing forward a lighting ashtray apparatus using solar energy, which is of ease of use at night with low cost and saves energy as well.

The present invention of a new practical apparatus will solve said technical problems by adopting the following technical schemes:

The ashtray apparatus designed for lighting using solar energy comprises an ash container, wherein a solar energy lighting device is configured on the top of the ash container, the said solar energy lighting device and the said ash container are configured and fixed on the support bracket; the said solar energy lighting device comprises an outer cover, photovoltaic cells, a rechargeable battery, a circuit controlled panel and a illuminant, wherein the photovoltaic cells are embedded on the upper surface of the outer cover, and the said rechargeable battery and the circuit controlled panel are configured inside of the said outer cover, and the said photovoltaic cells are connected to the said circuit controlled panel electrically which is further connected with the said rechargeable battery and the illuminant electrically. The said ashtray apparatus can be set on the trunks, the walls of buildings or other supporting objects in the open public places relying on its own support bracket when it is used.

The said illuminant is LED (light-emitting diode).

The said ash container comprises a cavity and a base, wherein the cavity has an opening for the ash entrance. The cavity and the base are hinged at the bottom end and buckled each other.

A padlock is configured on the ashtray apparatus, wherein a lock slider of the padlock is configured in the front of the cavity. When the padlock is locked, the pintle hook configured on the base is hooked by the lock hook of the padlock so as to buckle the base and the cavity.

The outer cover of the said solar energy lighting device shapes ellipse, and so does the ash container.

Compared with the prior art, the technique advantages of the lighting ashtray apparatus using solar energy according to the present inventive device are: 1. lighting by itself at night, which is of ease of use for smokers and meanwhile benefit for environmental protection; 2. lighting using solar energy, which saves energy and protects environment almost without any other cost.

### BRIEF DESCRIPTION OF THE DRAWINGS

FIG. 1 of the drawings is a tridimensional schematic view of an embodiment of the lighting ashtray apparatus using solar energy according to the present invention;

FIG. 2 of the drawings is a tridimensional schematic view of the embodiment that the container base is opened to let the cigarette ash cleaned;

FIG. 3 of the drawings is a decomposed schematic view of the embodiment of the ashtray apparatus lighting device 2.

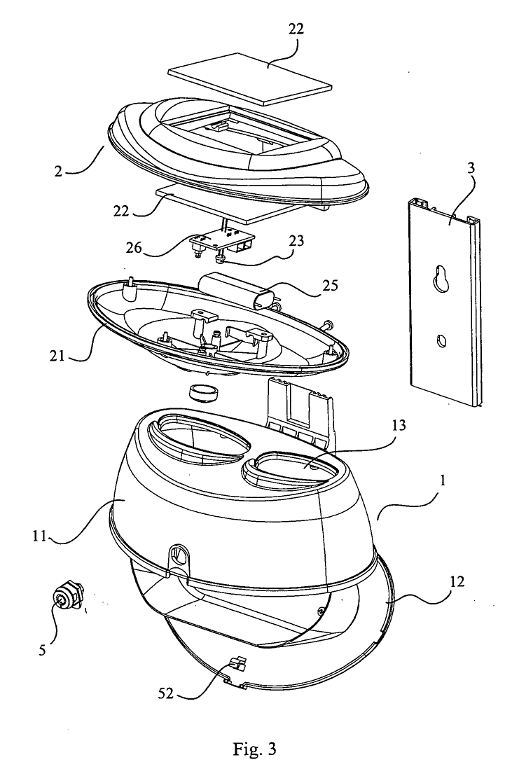

### DETAILED DESCRIPTION OF THE PREFERRED EMBODIMENT

The further detailed description will be given hereafter with the combination of the preferred embodiment of the drawings.

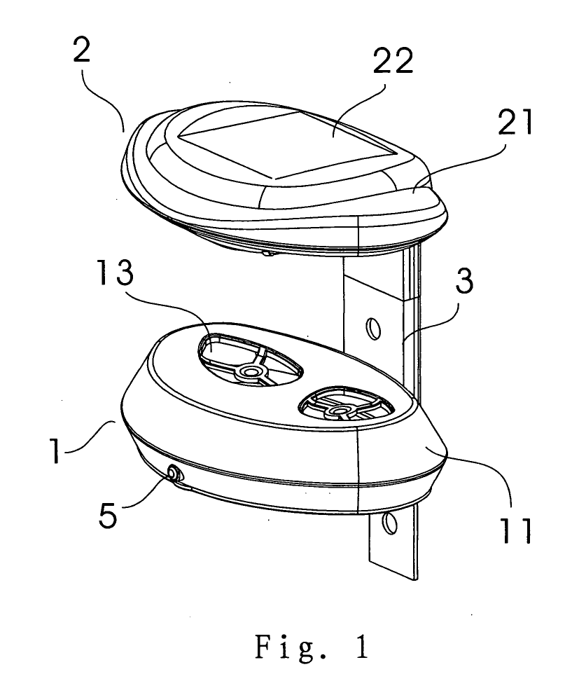

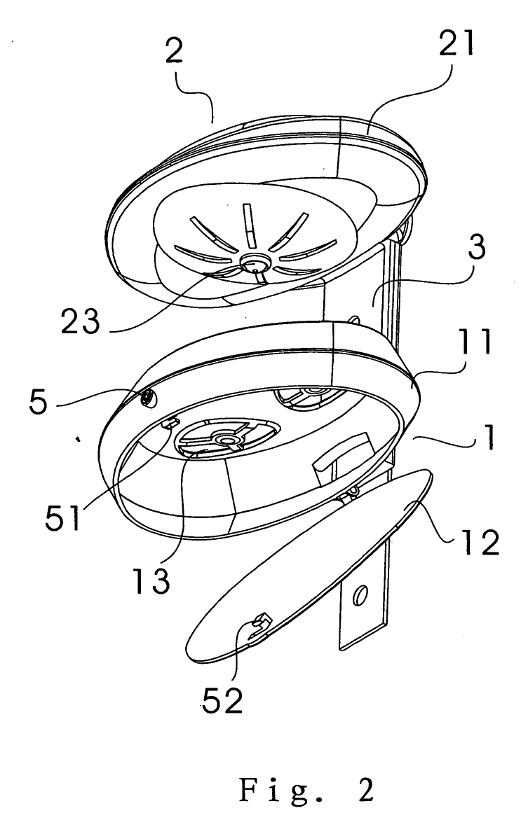

A lighting ashtray apparatus using solar energy as shown in FIG. 1 and FIG. 2, comprises an ash container 1, wherein a solar energy lighting device 2 is configured on the top of the ash container 1, the solar energy lighting device 2 and the ash container 1 are configured and fixed on the support bracket 3; the said solar energy lighting device 2 comprises an outer cover 21 shaping ellipse, photovoltaic cells 22, a rechargeable battery 25, a circuit controlled panel 26 and a illuminant 23, wherein the said photovoltaic cells 22 are embedded on the upper surface of the outer cover 21, the said rechargeable battery 25 and the circuit controlled panel 26 are configured inside of the said outer cover 21, the said photovoltaic cells 22 are connected to the said circuit controlled panel 26 electrically which is further connected with the said rechargeable battery 25 and the illuminant 23 electrically. The illuminant 23 is LED. The ashtray apparatus can be set and fixed on the trunks, the walls of buildings or other supporting objects in the open public places relying on its own support bracket 3 when it is used. The photovoltaic cells 22 charge the rechargeable battery (storage battery) depending on solar electric power generation at daytime, and at night, the LED lights depending on the power supply of the rechargeable battery. The technology of solar electric power generation and control circuit are both in existence, without any unnecessary details here.

The outer cover 21 of said solar energy lighting device shapes ellipse, and so does the corresponded ash container 1 which includes a cavity 11 and a base 12, wherein an ash entrance 13 is configured on the cavity 11; the cavity 11 and the base 12 are hinged on the bottom end and buckled each other. A padlock 5 is further configured on said ash container 1, and the lock slider of said padlock 5 is configured on the top end of the cavity 11. When the padlock is locked, the pintle hook 52 configured on the base 12 is hooked by the lock hook 51 of the padlock so as to buckle the base 12 and the cavity 11. When cigarette ash needs to be cleaned, as shown in FIG. 2, the base 12 can be opened by releasing the padlock and then the cigarette ash in the container 1 can be cleaned.

1. A lighting ashtray apparatus using solar energy, comprising an ash container, characterized by that:
A solar energy lighting device is configured on the top side of said ash container, said solar energy lighting device and the ash container are both configured and fixed on the support bracket;
said solar energy lighting device comprises an outer cover, photovoltaic cells, a rechargeable battery, a circuit controlled panel and a illuminant, wherein said photovoltaic cells are embedded in the upper surface of the outer cover, and said rechargeable battery and the circuit controlled panel are configured inside of the outer cover, and the photovoltaic cells are connected to the circuit controlled panel electrically which is further connected with the rechargeable battery and the illuminant electrically.

2. A lighting ashtray apparatus using solar energy as claimed in claim 1, characterized by that:
The illuminant is LED.

3. A lighting ashtray apparatus using solar energy as claimed in claim 1, characterized by that:
The ash container comprises a cavity and a base, wherein an ash entrance is configured on the cavity;
said cavity and the base are hinged on the bottom end and buckled each other.

4. A lighting ashtray apparatus using solar energy as claimed in claim 1, characterized in that:
A padlock is further configured on the ash container, and the lock slider of the padlock is configured on the top end of the cavity, when the padlock is locked, the pintle hook configured on the base is hooked by the lock hook so as to buckle the base and the cavity.

5. A lighting ashtray apparatus using solar energy as claimed in claim 1, characterized by that:
The shape of the outer cover of said solar energy lighting device is ellipse, and so is the ash container.
